(19) United States
(12) Patent Application Publication
(10) Pub. No.: US 2014/0033780 A1
(43) Pub. Date: Feb. 6, 2014

(54) METAL-CONTAINING COATING AND METHOD OF USING AND MAKING SAME

(71) Applicant: LIQUIDMETAL COATINGS LLC, Humble, TX (US)

(72) Inventors: Choongnyun P. KIM, Northridge, CA (US); John KANG, Kingwood, TX (US)

(73) Assignee: LIQUIDMETAL COATINGS LLC, Humble, TX (US)

(21) Appl. No.: 13/827,427

(22) Filed: Mar. 14, 2013

Related U.S. Application Data
(60) Provisional application No. 61/679,399, filed on Aug. 3, 2012.

(51) Int. Cl. C09D 1/00; B05D 7/22

(52) U.S. Cl. CPC C09D 1/00; B05D 7/22
USPC 72/46; 427/230; 420/591

(57) ABSTRACT

One embodiment provides a method of making a coating composition, the method comprising: contacting a first material comprising at least one first alloy comprising at least a first element and a second element with an interior surface of a second hollow material comprising at least one ferrous second alloy to form a preform; and heating at least a portion of the preform to promote intermixing of at least some of the first material and the second material to form the coating composition.

### RELATED APPLICATION

This application claims priority to U.S. Provisional Application Ser. No. 61/679,399, filed Aug. 3, 2012, which is hereby incorporated by reference in its entirety.

### BACKGROUND

Industrial tools generally have coatings disposed over them to provide protection against corrosion and other environmental damages. Generally, the coatings contain metal alloys that are fabricated by mixing individual alloy elements in an alloying process at an elevated temperature. However, such a fabrication process often produces a large amount of fumes (or “degassing”) as a byproduct during the alloying process. The fumes not only may be health hazards but also make the fabrication process more difficult to control.

The gas generated during the alloying process may result in coating products having a high level of porosity, which undesirably prevents the formation of a dense coating. Also, the high temperature involved during the alloying process may cause thermal stress in the coating product, which may eventually result in cracks in the final coating product.

The coatings fabricated by the pre-existing methods further face the challenge of a lack of versatility. Specifically, the coating may need to be tailored for the specific substrate the coating is to be disposed over. A coating not tailored specifically for the substrate generally results in delamination of the coating from the substrate.

### SUMMARY

In view of the foregoing, the Inventors have recognized and appreciated the advantages of a versatile metal-containing coating and methods of making and using the coating. The coatings described herein may be versatile with respect to any substrate over which the coating may be disposed. Also, the methods described herein may produce the aforementioned coatings without the challenges of the pre-existing coating production techniques.

Accordingly, provided in one embodiment is a method of making a coating composition, the method comprising: contacting a first material comprising at least one first alloy comprising at least a first element and a second element with an interior surface of a second hollow material comprising at least one ferrous second alloy to form a preform; and heating at least a portion of the preform to promote intermixing of at least some of the first material and the second material to form the coating composition.

Another embodiment provides a method of making a coating composition, the method comprising: forming a tubular preform having a first diameter and comprising a core and a sheath exterior to the core, wherein the core comprises a first material comprising at least one first alloy comprising at least a first element and a second element and the sheath comprises at least one second ferrous alloy; drawing at least a portion of the preform such that the drawn portion of the preform has a second diameter, wherein the second diameter is smaller than the first diameter; disposing at least the drawn portion of the preform over a substrate; and heating the disposed drawn portion of the preform to promote intermixing of at least some of the first material and the second material to form the coating composition over the substrate.

Another embodiment provides a coating composition, wherein the coating composition is formed by a method comprising: contacting a first material comprising at least one first alloy comprising at least a first element and a second element with an interior surface of a second hollow material comprising at least one ferrous second alloy to form a preform; and heating at least a portion of the preform to promote intermixing of at least some of the first material and the second material to form the coating composition.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 provides a schematic of a preform in one exemplary embodiment.

FIG. 2 provides a schematic flowchart showing a process of making a preform in one exemplary embodiment.

FIG. 3 provides a schematic flowchart showing a process of making a preform in one exemplary embodiment.

FIGS. 4(a)-4(b) provide micrographs of a coating sample prepared by a pre-existing method and by a method described herein, respectively, in one exemplary embodiment.

### DETAILED DESCRIPTION

Following are more detailed descriptions of various concepts related to, and embodiments of, an inventive metal-containing coating and methods of making and using the coating. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

The methods described herein in some embodiments are related to making a coating composition, the coating composition (or “coating” for short”) may be disposed over (or directly on, in some instances) any substrate. The substrate may be a part of any structural component. The structural component may be a tool or a part of a device or building structure. The tool may be an industrial tool, such as one in the oil or gas industry, electronic industry, aerospace industry, power-generating industry, etc. For example, the structural component may be a drill, a drill pipe, a tool joint, etc. In some embodiments, the structural components may be any portion of a tool or device where the portion is subjected to erosion, abrasion, and/or corrosion and may benefit from having a coating to help extend its useful life.

In one embodiment, the methods include contacting a first material comprising at least one first alloy comprising at least a first element and a second element with an interior surface of a second hollow material comprising at least one ferrous second alloy to form a preform; and heating at least a portion of the preform to promote intermixing of at least some of the first material and the second material to form the coating composition. The terms “first,” “second,” etc. are used merely to denote different entities and are not meant to limit the sequence or nature of the entities.

An alloy may refer to a solid solution of two or more metal elements (e.g., at least 2, 3, 4, 5, or more elements) or an intermetallic compound (including at least one metal element and at least one non-metal element). The term “element” herein may refer to the elements that may be found in the Periodic Table. A metal may refer to any of alkali metals, alkaline earth metals, transition metals, post-transition metals, lanthanides, actinides, and metalloids.

The first alloy may have any suitable chemical composition, depending on the application. In some instances, the first alloy in a method described herein may be referred to as a “pre-alloy” or “master alloy,” as the elements of the first alloy have been pre-alloyed before being brought in contact with the second material. Any alloying techniques to fabricate the pre-alloy may be used—e.g., ball milling, grinding, etc. The first alloy may contain two, three, or more elements. The elements may be any non-gas and non-liquid elements found in the Periodic Table. For example, the elements may be a metal or a metalloid element. In some instances, a non-metal element, such as C, P, S, etc., may also be possible.

The first alloy may be a ferrous alloy (or “ferroalloy”), although other types of alloys may also be employed. A ferrous alloy may comprise Fe, Al, B, Ce, Cr, Mg, Mn, Mo, Nb, Ni, P, Si, Ti, U, V, W, or combinations thereof. In one embodiment wherein the first alloy has at least two elements, at least one of the first element and the second element is one of Fe, Cr, Mo, Mn, B, C, P, S, Mn, Si, Zr, and Ti. In one embodiment, the first alloy comprises an alloy based on Mn—Si—Fe, Fe—B, Fe—Mo, Fe—V, Fe—Nb, Fe—Ti, Fe—Al, Fe—P, Fe—Si, or combinations thereof. Other types of ferroalloys are also possible. Note that the symbols in the aforedescribed alloys are meant to denote the elements present in the alloy and not their respective content in the alloys. In one embodiment, a “XY-based” alloy herein may refer to an alloy comprising a significant portion of elements X and Y; a significant portion may refer to at least 5%—e.g., at least 10%, 15%, 20%, 25%, or more. The percentage herein may refer to volume percentage or weight percentage, depending on the context.

The first material may include the first alloy, consist essentially of the first alloy, or consist of the first alloy, depending on the application. The first material may contain more than one alloy. For example, the first material may contain at least two, three, four, five, or more, alloys. In one embodiment, the first material may consist essentially of, or consist of these alloys. The first material may contain additional elements that are not in an alloy form. For example, the first material may contain additional metal and/or non-metal elements in their elemental form.

The additional elements may be employed when the first material and the second material together do not provide the certain elements desired for the preform and/or final coating composition. In other words, the additional elements may act as an additional (to the first and second materials) source of elements for the preform and/or the final coating. Thus, the additional elements may be any elements that are desired and are not limited in any way. In one embodiment, the additional elements may be C, Cr, Mn, or combinations thereof. In one embodiment wherein there is an additional element, the additional element is not Mn. In the instance where the first alloy (or other additional alloys of the first material) and the second material provide all the elements needed in the preform and/or coating composition, no additional elements are needed.

The first material may have any geometry. In one embodiment, the first material comprises a mixture, including at least one of the first alloy and/or other additional elements. The mixture may be a powder or any other geometry. The first material may contain more than one alloy, such as at least two, three, four, or more, alloys. In one embodiment, at least a portion of the first material is in a form of a powder. In one embodiment, the at least first alloy and/or the additional elements may be powder of any suitable size. In some embodiments, the powder of the first material has a mesh size of from about 28 to about 2400—e.g., about 30 to about 2000, about 50 to about 1500, about 100 to about 1000, about 200 to about 800, about 300 to about 600, about 400 to about 500, etc. In one embodiment, the mesh size is from about 60/325 to about 60/200. \\ The size of the powder of the first alloy may be the same, greater than, or smaller than that of the additional elements, depending on the application.

The first material may contain Mn as an element. The Mn element may be one element of the first alloy, as opposed to the additional element, though it may also be the additional element. In one embodiment, having Mn in an alloy form (e.g., as a part of the at least one first alloy) and not the additional element is distinct from the pre-existing fabrication methods of a coating, wherein all of the individual elements, including Mn, are mixed together. In one embodiment, the at least one first alloy may comprise Fe—Mn, Fe—Mn—Si, or both. Not to be bound by any particular theory, but the inclusion of Mn in its elemental form (as opposed to an alloy form) may result in degassing and fuming during the alloying process to create a coating. Thus, in one embodiment, avoiding having Mn in an element form surprisingly may allow the methods described herein to produce a coating without degassing or with reduced degassing.

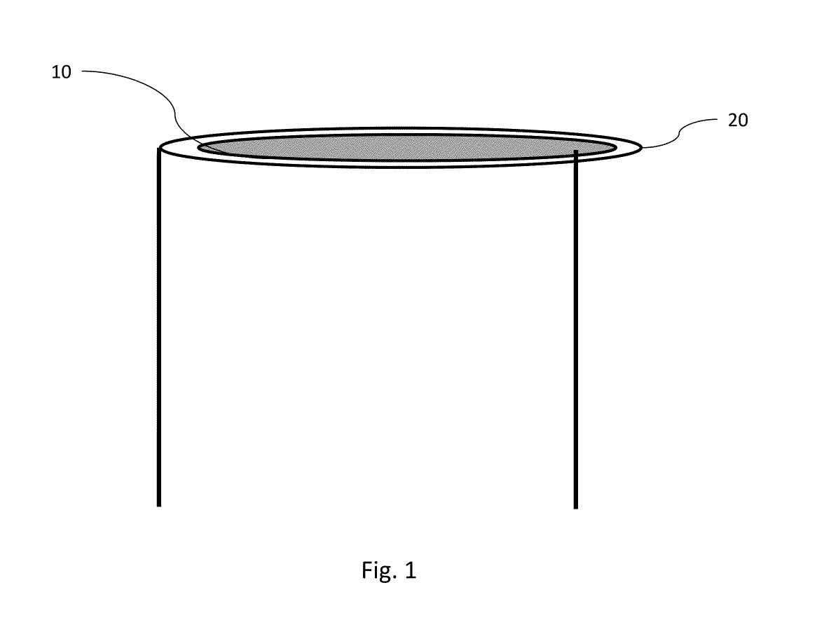

The second material may comprise an alloy, such as a ferrous alloy. The ferrous alloy may be any of the ferrous alloys known, including those described above. The second material may take any suitable shape, such as a hollow geometry or a flat geometry. In one embodiment, the second material is a hollow tube. In one embodiment wherein the second material is a hollow tube, the preform may resemble a hollow sheath-like structure comprising the second material surrounding an internal core comprising the first material, as shown in FIG. 1. Thus, the preform may have a tubular geometry—e.g., wire. Other geometries of the preform may also be employed, depending on the application. The second material may start out as a flat plate or strip and be rolled into a hollow geometry to be brought into contact with the first material. Alternatively, the first and second materials may be brought into contact with the first material disposed over the second material and then these two materials are rolled together as in a method of rolling a cigarette. In one embodiment, the flat plate or strip of the second material may further undergo hardening, such as work hardening, while being processed into a hollow geometry.

The ferrous second alloy may have any suitable composition, depending on the application. In some instances, the ferrous alloy may comprise elements Fe, Ni, Cr, or combinations thereof. In one embodiment, the ferrous alloy may be a steel, including a stainless steel. A stainless steel herein may refer to 304L stainless steel, 430 stainless steel, or other types of stainless steel. In one embodiment, a 304L stainless steel may be used if it is desired to have Ni in the final coating composition.

Depending on the application, the first material may be a certain percentage of the preform and also the final coating composition. In one embodiment, the first material is by weight about 10% to about 80% of the preform—e.g., about 20% to about 60%, about 30% to about 50%, about 35% to about 45% of the preform. On the other hand, the second material may be a certain percentage of the preform and also the final coating composition. In one embodiment, the second material is by weight about 30% to about 90% of the preform—e.g., about 40% to about 80%, about 50% to about 70%, about 55% to about 65% of the preform. These percentages may refer to volume percentage, as well, depending on the context. In some embodiments, particularly those in which the chemical composition does not alter significantly from the preform to the final coating composition, the aforedescribed percentages may also apply to the coating composition.

After bringing the first material and the second material into contact, a preform may be formed. The contact herein may refer to physical contact. In one embodiment wherein the second material is the form of a hollow structure, the first material may be brought into contact with the interior surface of the second material. In such a case, the preform may resemble a wire with an internal core containing the first material 10 and an outer sheath containing the second material 20, as shown in FIG. 1. Alternatively, the second material may be in the form of a plate and the combination of the first material (disposed over the second material) and the first material may be rolled together to form a preform, as described above.

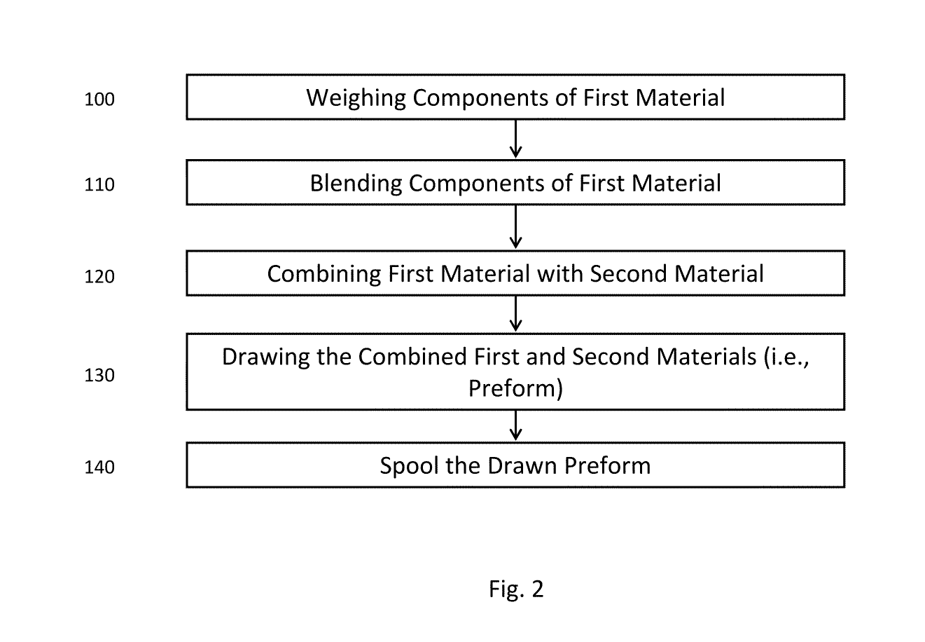

FIG. 2 provides a schematic flowchart showing the process involved in one exemplary embodiment. The formation of the preform may include weighing the individual components 100 (e.g., the pre-alloy and the optional additional elements as described above) of the first material to have the desired amount and mixing them 110 (in the case of multiple components) to form the first material. The pre-alloy may be formed elsewhere before the step of weighing. For example, the pre-alloy may be purchased from commercial vendors prior to the formation process. The mixing may take the form of blending 110. The blended first material may then be brought into contact with the second material to form a wire-like preform 120 (or “wiring”).

The preform need not be disposed over a substrate right away. For example, the wire-shape preform may optionally undergo drawing 130 to reduce the diameter thereof and/or to be rolled into a spool 140. In some instances, the preform is further drawn to reduce the diameter of the preform. The preform may be drawn once or multiple times, depending on the desired diameter. In one embodiment, the drawn preform may be spooled into a spool 140, which is later provided on site for coating application to undergo the heating and other process described herein.

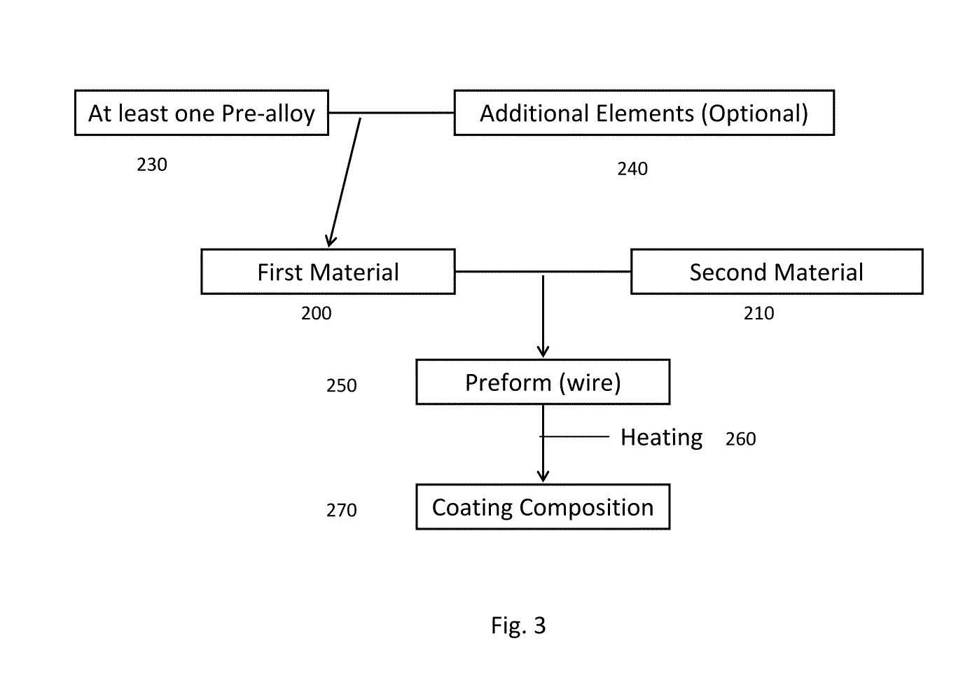

FIG. 3 provides a schematic flowchart showing the process of making a coating composition in one embodiment. As shown in FIG. 3, the preform is formed by contacting the first material 200 (at least one pre-alloy 230 and optionally additional elements 240) (e.g., as a core) and the second material (e.g., as a sheath) to form a perform 250, which is then subsequently heated 260 to promote intermixing of the first and the second material to form a coating composition 270. In one embodiment, during formation of the coating composition, the preform may be disposed over a substrate to form the coating composition, which substrate may be any of the aforedescribed substrates. In some instances, the substrate may already include a coating, and the coating compositions described herein may be coated on top of that coating. The substrate may contain carbon steel, including stainless steel. The substrate may also contain titanium (Ti 6-4, beta Ti, etc.) and/or its alloy and/or aluminum alloys.

During formation of the coating composition, the preform described herein may be heated to promote intermixing of at least some of the first material and the second material. The heating may involve welding, cladding, thermal spraying, or combinations thereof. Thermal spraying may involve plasma spraying, oxygen-fuel coating spraying (HVOF), twin wire arc spraying (TWAS), or combinations thereof. As a result of the intermixing, at least a portion of the first material becomes alloyed with at least a portion of the second material. In some instances, a substantial portion, such as substantially all or all, of the portions of the first material is alloyed with the second material to form a preform alloy that becomes the final coating composition. In contrast to the pre-existing coating formation process, the coating described in at least one embodiment herein is formed from a preform containing at least one alloy (or even consisting of the alloy) instead of a preform containing all elements thereof in elemental form. In one embodiment, the chemical composition of the preform is at least substantially the same as that of the coating composition; in another embodiment, the two chemical compositions of the two are the same.

In some embodiments, at least one distinguishable feature of the methods described herein, as compared to the pre-existing coating formation technique, is that the preform described herein contains at least one “pre-alloy,” as opposed to the pre-existing methods of mixing every element individually to form the preform and coating without any of them in an alloy form prior to the formation of the coating. As a result, the methods and the coating compositions produced therefrom described in some embodiments herein exhibit several surprising beneficial results, as described below.

Not to be bound by any particular theory, but at least because several (if not all) of the elements involved are already in a pre-alloy form (in both the first and second materials), as opposed to elemental form (of pre-existing methods), the combination of the pre-alloy of the first material core with the second alloy exterior sheath may result in reduction (or complete lack thereof) of degassing during fabrication process and/or in a preform that has a lower level of porosity (and thus is denser or has a higher packing density) than one that is made from a combination of individual elements in elemental form (as in a pre-existing method).

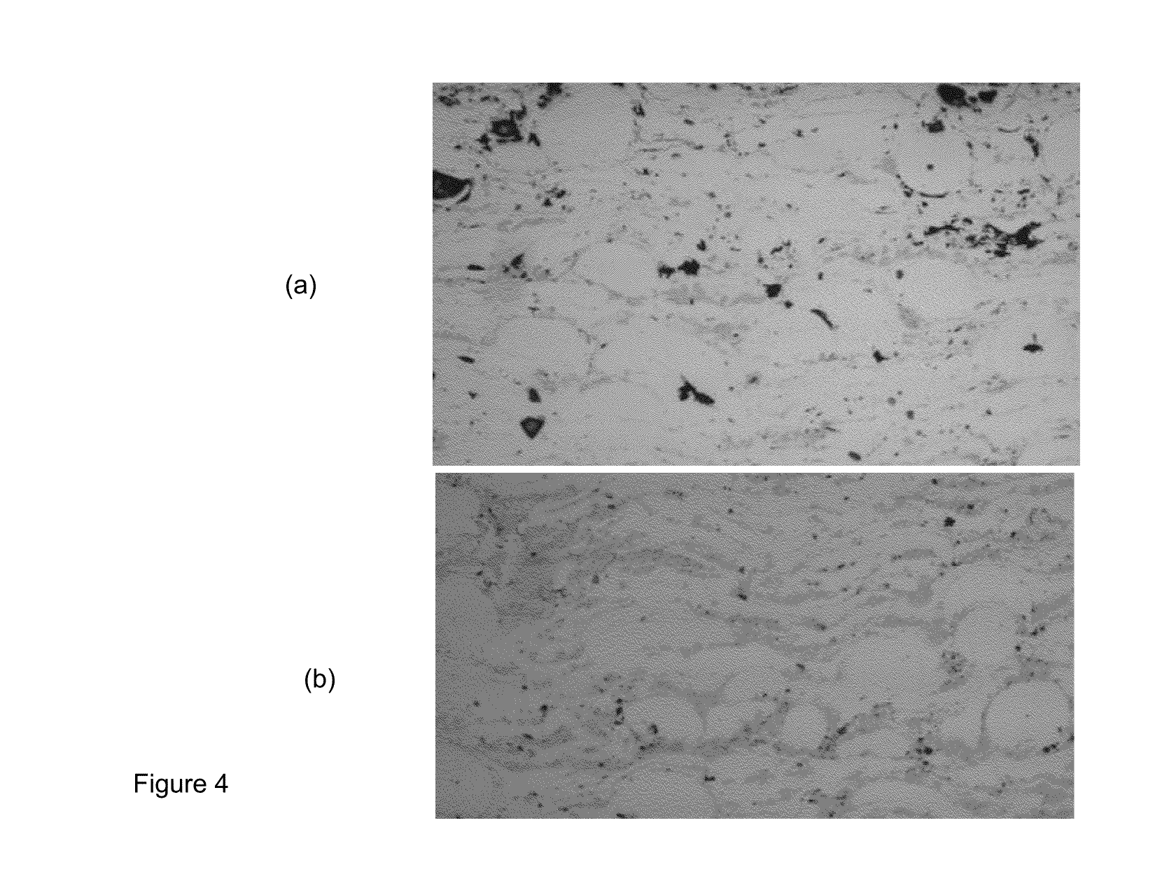

As shown in FIGS. 4(a) and 4(b), a coating produced by the methods described herein in one embodiment (FIG. 4(b)) exhibits a much lower level of oxides (shown as black dots in the figures) than another alloy sample produced by a pre-existing method (FIG. 4(a))—the two samples had the same chemical compositions and the only difference between the two is the methods of making these samples. As shown in the figures, the coating produced by the methods described at least in this embodiment is cleaner—e.g., lower in impurity (e.g., oxide)—and/or denser (e.g., lower level of porosity or higher packing density) than that produced by a pre-existing method. In one embodiment, the coating produced by the methods described herein may be more homogeneous with respect to the constituents (e.g., different alloys and/or elements) distribution in the final coating composition than a coating produced by a pre-existing method. Also, in comparison to the pre-existing methods, the coatings fabricated by the methods described herein may have a higher hardness value, higher tensile strength, and/or higher resistance to crack formation or propagation (e.g., fewer observable cracks).

In one embodiment, the coatings formed by the methods described herein exhibit fewer cracks than a coating fabricated by pre-existing methods of combining individual elements. In another embodiment, the coatings fabricated by the method described herein may have a lower melting point than a coating fabricated by pre-existing methods of combining individual elements. Not to be bound by any particular theory, but the lowering of the melting point may be attributed to the presence of an eutectic melting temperature (for an alloy) as opposed to melting temperatures of individual elements—an eutectic melting temperature of an alloy of several elements is generally lower than the melting temperatures of these individual elements otherwise in elemental form.

In one embodiment, at least one benefit of the lower melting temperature (or processing temperature) during the formation of the coating is to prevent formation of cracks. In many instances, cracks may form as a result of residual thermal stress arising from the high processing temperature. Accordingly, lowering the processing temperature (and/or melting temperature) of the material involved may reduce the thermal stress, thereby mitigating crack formation. In one embodiment, the crack may refer to a surface crack or a through-thickness (of the coating) crack. In some embodiments, such a process described herein may result in a smoother surface finish. In some embodiments, additional post-processing steps, such as etching, polishing, etc., may still be applied to provide a different level of surface finish. Furthermore, not to be bound by any particular theory, but at least because of the improvement of the structural integrity of the coating composition, the coating described herein may be disposed over any substrate, instead of being specific to only a certain type of substrate—this is in stark contrast to the coatings produced by pre-existing methods, which are specific with respect to their substrate.

As described above, methods described herein generally produce less fumes (or degassing) during the formation of the coating composition, in comparison to pre-existing methods. Not to be bound by any particular theory, but the reduced (or even total lack of) degassing in the methods described herein may be due to the fact that degassing has already taken place during the formation of the pre-alloy, which is prior to the formation of the preform, in at least one embodiment described herein. This is in contrast to the pre-existing methods, during which an alloy is formed for the first time during coating formation. In other words, in one embodiment, the use of a pre-alloy in the methods described herein may enable bypassing the degassing stage that would have otherwise taken place in the pre-existing methods. The avoidance of degassing may be beneficial, particularly in embodiments that contain Mn. For example, instead of using metal Mn in elemental form, using a pre-alloy containing Mn may avoid degassing of Mn gas, which may be toxic.

Also, not to be bound by any particular theory, but at least because of the use of a pre-alloy, as opposed to having all elements in elemental form, the intermixing (during the heating or alloying of the first material and second material) may take place at a lower temperature. In some embodiments, during the step of heating and/or disposing, substantially no, including completely no, degassing takes place. Further, during the intermixing process (as a result of heating), the coating compositions fabricated by the methods described herein may exhibit less spattering during the heating than a different coating composition produced from a preform comprising the first element and the second element in a non-alloy form. In one embodiment, the coatings fabricated by the methods described herein may have a higher disposing rate during the disposing than a coating fabricated by conventional methods.

Depending on the chemical composition of the first and second materials, the preform and the final coating composition may be of various chemical compositions. For example, the preform (and/or final coating composition) may be a ferrous alloy, as any of those aforedescribed. The alloy may contain, for example, C at about 0.5% to about 2% (e.g., about 1.1% to about 1.7%), Mn at about 0.5% to about 2.5% (e.g., about 0.8% to about 1.6%), Si at about 0.2% to about 2.0% (e.g., about 0.4% to about 1.0%), Cr at about 5% to about 30% (e.g., about 24.2% to about 28.2%, about 6% to about 7.5%), Nb at about 4% to about 8% (e.g., about 5% to about 6%), V at about 0.2% to about 1% (e.g., about 0.5% to about 0.8%), Ti at about 0.05% to about 0.5% (e.g., about 0.1% to about 0.3%), and/or Ni at about 3% to about 10% (e.g., about 4.5% to about 7%), and/or B at about 1% to about 5% (e.g., about 3.2% to about 3.7%), and balanced by Fe. Other elements and contents are also possible.

### ADDITIONAL EMBODIMENTS

The following additional embodiments are taken from the claims of U.S. Provisional Patent Application Ser. No. 61/679,399, to which the present application claims priority.

1. A method of making a coating composition, the method comprising: contacting a first material comprising at least one first alloy comprising at least a first element and a second element with an interior surface of a second hollow material comprising at least one ferrous second alloy to form a preform; and heating at least a portion of the preform to promote intermixing of at least some of the first material and the second material to form the coating composition.

2. The method of embodiment 1, wherein the at least one first alloy comprises a ferrous alloy.

3. The method of embodiment 1, wherein the at least one of the first element and the second element is one of Fe, Cr, Mo, Mn, B, C, P, S, Mn, Si, Zr, and Ti.

4. The method of embodiment 1, wherein the at least one first alloy comprises an alloy based on Mn—Si—Fe, Fe—B, Fe—Mo, Fe—V, Fe—Nb, Fe—Ti, Fe—Al, Fe—P, Fe—Si, or combinations thereof.

5. The method of embodiment 1, wherein at least a portion of the first material is in a form of a powder.

6. The method of embodiment 1, wherein the at least one ferrous second alloy comprises elements Fe, Ni, Cr, or combinations thereof.

7. The method of embodiment 1, wherein the at least one ferrous second alloy comprises at least one of steel and stainless steel.

8. The method of embodiment 1, wherein the first material is by weight about 30% to about 50% of the preform.

9. The method of embodiment 1, wherein the second material is by weight about 50% to about 70% of the preform.

10. The method of embodiment 1, further comprising mixing at least one additional element with the at least one first alloy to form the first material.

11. The method of embodiment 1, further comprising mixing at least one additional element with the at least one alloy to form the first material, the additional element being at least one of C and Cr.

12. The method of embodiment 1, wherein the heating further comprises disposing the preform over a substrate and forming the coating composition over the substrate.

13. The method of embodiment 1, further comprising drawing the preform before the heating.

14. The method of embodiment 1, wherein the preform has a shape of a wire.

15. The method of embodiment 1, wherein the heating involves substantially no degassing from the intermixing.

16. The method of embodiment 1, wherein the preform has a lower melting point than a different preform comprising at least the first element and the second element in a non-alloy form.

17. The method of embodiment 1, wherein the coating composition has a higher density than a different coating composition produced from a preform comprising at least the first element and the second element in a non-alloy form.

18. The method of embodiment 1, wherein the coating composition has a higher hardness value than a different coating composition produced from a preform comprising at least the first element and the second element in a non-alloy form.

19. The method of embodiment 1, wherein the coating composition exhibits fewer cracks than a different coating composition produced from a preform comprising at least the first element and the second element in a non-alloy form.

20. The method of embodiment 1, wherein the coating composition exhibits less spattering during the heating than a different coating composition produced from a preform comprising the first element and the second element in a non-alloy form.

21. A method of making a coating composition, the method comprising: forming a tubular preform having a first diameter and comprising a core and an sheath exterior to the core, wherein the core comprises a first material comprising at least one first alloy comprising at least a first element and a second element and the sheath comprises at least one second ferrous alloy; drawing at least a portion of the preform such that the drawn portion of the preform has a second diameter, wherein the second diameter is smaller than the first diameter; disposing at least the drawn portion of the preform over a substrate; and heating the disposed drawn portion of the preform to promote intermixing of at least some of the first material and the second material to form the coating composition over the substrate.

22. The method of embodiment 21, further comprising forming the at least one first alloy before the contacting.

23. The method of embodiment 21, further comprising forming the first material by mixing the at least one first alloy with at least one additional element.

24. The method of embodiment 21, wherein the heating involves substantially no degassing from the intermixing.

25. The method of embodiment 21, wherein the first material comprises Mn, which is one of the first and second elements of the at least first alloy.

26. The method of embodiment 21, wherein the heating involves welding, cladding, thermal spraying, or combinations thereof.

27. The method of embodiment 21, wherein the first material comprises at least two alloys.

28. The method of embodiment 21, wherein the first material consists essential of the at least first alloy and at least one additional element that is one of C and Cr.

29. The method of embodiment 21, wherein the substrate is a part of an industrial tool.

30. The method of embodiment 21, wherein the coating composition exhibits a higher disposing rate during the disposing than a different coating composition produced from a preform comprising the first element and the second element in a non-alloy form.

31. A coating composition, wherein the coating composition is formed by a method comprising: contacting a first material comprising at least one first alloy comprising at least a first element and a second element with an interior surface of a second hollow material comprising at least one ferrous second alloy to form a preform; and heating at least a portion of the preform to promote intermixing of at least some of the first material and the second material to form the coating composition.

32 The coating composition of embodiment 31, wherein the preform has a lower melting point than a different preform comprising at least the first element and the second element in a non-alloy form.

33. The coating composition of embodiment 31, wherein the coating composition has a higher density than a different coating composition produced from a preform comprising at least the first element and the second element in a non-alloy form.

34. The coating composition of embodiment 31, wherein the coating composition has a higher hardness value than a different coating composition produced from a preform comprising at least the first element and the second element in a non-alloy form.

35. The coating composition of embodiment 31, wherein the coating composition exhibits fewer cracks than a different coating composition produced from a preform comprising at least the first element and the second element in a non-alloy form.

36. The coating composition of embodiment 31, wherein the coating composition exhibits less spattering during the heating than a different coating composition produced from a preform comprising at least the first element and the second element in a non-alloy form.

37. The coating composition of embodiment 31, wherein the coating composition exhibits lower amount of porosity during the heating than a different coating composition produced from a preform comprising at least the first element and the second element in a non-alloy form.

38. The coating composition of embodiment 31, wherein the intermixing of the preform takes place at a lower temperature than that of a different coating composition produced from a preform comprising at least the first element and the second element in a non-alloy form.

39. The coating composition of embodiment 31, wherein the first material comprises a powder comprising at least the first alloy.

40. The coating composition of embodiment 31, wherein the first material comprises Mn, which is one of the first and the second element of the first alloy.

41. The coating composition of embodiment 31, wherein at least a portion of the first material is in a form of a powder having a mesh size of about 60/325 to about 60/200.

### CONCLUSION

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, described techniques, or the like, this application controls.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The terms “substantially” and “about” used throughout this Specification are used to describe and account for small fluctuations. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed:

1. A method of making a coating composition, the method comprising:
contacting a first material comprising at least one first alloy comprising at least a first element and a second element with an interior surface of a second hollow material comprising at least one ferrous second alloy to form a preform; and
heating at least a portion of the preform to promote intermixing of at least some of the first material and the second material to form the coating composition.

2. The method of claim 1, wherein the at least one first alloy comprises a ferrous alloy.

3. The method of claim 1, wherein the at least one of the first element and the second element is one of Fe, Cr, Mo, Mn, B, C, P, S, Mn, Si, Zr, and Ti.

4. The method of claim 1, wherein at least one first alloy comprises an alloy based on Mn—Si—Fe, Fe—B, Fe—Mo, Fe—V, Fe—Nb, Fe—Ti, Fe—Al, Fe—P, Fe—Si, or combinations thereof.

5. The method of claim 1, wherein at least a portion of the first material is in a form of a powder.

6. The method of claim 1, wherein the at least one ferrous second alloy comprises elements Fe, Ni, Cr, or combinations thereof.

7. The method of claim 1, wherein the first material is by weight about 30% to about 50% of the preform.

8. The method of claim 1, wherein the second material is by weight about 50% to about 70% of the preform.

9. The method of claim 1, further comprising mixing at least one additional element with the at least one first alloy to form the first material.

10. The method of claim 1, wherein the heating further comprises disposing the preform over a substrate and forming the coating composition over the substrate.

11. The method of claim 1, further comprising drawing the preform before the heating.

12. The method of claim 1, wherein the preform has a shape of a wire.

13. The method of claim 1, wherein the heating involves substantially no degassing from the intermixing.

14. The method of claim 1, wherein the preform has a lower melting point than a different preform comprising at least the first element and the second element in a non-alloy form.

15. The method of claim 1, wherein at least one of the following is true:
the coating composition exhibits less spattering during the heating than a different coating composition produced from a preform comprising the first element and the second element in a non-alloy form,
the coating composition exhibits a lower amount of porosity during the heating than a different coating composition produced from a preform comprising at least the first element and the second element in a non-alloy form; and
the intermixing of the preform takes place at a lower temperature than that of a different coating composition produced from a preform comprising at least the first element and the second element in a non-alloy form.

16. A method of making a coating composition, the method comprising:
forming a tubular preform having a first diameter and comprising a core and a sheath exterior to the core, wherein the core comprises a first material comprising at least one first alloy comprising at least a first element and a second element and the sheath comprises at least one second ferrous alloy;
drawing at least a portion of the preform such that the drawn portion of the preform has a second diameter, wherein the second diameter is smaller than the first diameter;
disposing at least the drawn portion of the preform over a substrate; and
heating the disposed drawn portion of the preform to promote intermixing of at least some of the first material and the second material to form the coating composition over the substrate.

17. The method of claim 15, further comprising forming the at least one first alloy before the forming.

18. The method of claim 15, wherein the first material comprises Mn, which is one of the first and second elements of the at least first alloy.

19. The method of claim 15, wherein the heating involves welding, cladding, thermal spraying, or combinations thereof.

20. The method of claim 15, wherein the first material comprises at least two alloys.

21. The method of claim 15, wherein the first material consists essentially of the at least first alloy and at least one additional element that is one of C and Cr.

22. The method of claim 15, wherein the substrate is a part of an industrial tool.

23. The method of claim 15, wherein the coating composition exhibits a higher disposing rate during the disposing than a different coating composition produced from a preform comprising the first element and the second element in a non-alloy form.

24. A coating composition, wherein the coating composition is formed by a method comprising:
contacting a first material comprising at least one first alloy comprising at least a first element and a second element with an interior surface of a second hollow material comprising at least one ferrous second alloy to form a preform; and
heating at least a portion of the preform to promote intermixing of at least some of the first material and the second material to form the coating composition.

25. The coating composition of claim 24, wherein the coating composition has at least one of a higher density, a higher hardness value, or fewer cracks than a different coating composition produced from a preform comprising at least the first element and the second element in a non-alloy form.

26. The coating composition of claim 24, wherein at least a portion of the first material is in a form of a powder having a mesh size of about 60/325 to about 60/200.
